(19) United States
(12) Patent Application Publication
(10) Pub. No.: US 2011/0147281 A1
(43) Pub. Date: Jun. 23, 2011

(54) Hinged Disc for Disc Screen

(75) Inventor: Robert M. Davis, National City, CA (US)

(73) Assignee: CP MANUFACTURING, INC., National City, CA (US)

(21) Appl. No.: 13/025,072

(22) Filed: Feb. 10, 2011

Related U.S. Application Data
(63) Continuation of application No. 11/305,653, filed on Dec. 18, 2005.

(51) Int. Cl. B07B 1/14; B07B 13/04; B07B 1/46

(52) U.S. Cl. 209/671

(57) ABSTRACT

A disc for releasable attachment to a shaft of a disc screen apparatus includes a generally ring-shaped hub. The hub has a bore and a split defining a pair of opposing ends. The hub also has a hinge intermediate the opposing ends that permits the opposing ends of the hub to be separated a predetermined distance sufficient to allow the shaft of the disc screen apparatus to pass between the opposing ends into the bore. A plurality of outer impacting elements are supported on the hub and are configured for engaging materials to be classified and propelling the materials in a conveying direction when the hub is rotated. A mechanism is provided to secure the hub to the shaft so that the shaft extends through the bore.

### RELATED APPLICATION

The present application is a Continuation of co-pending U.S. patent application Ser. No. 11/305,653, filed Dec. 18, 2005, the contents of which are incorporated herein by reference in their entirety.

### BACKGROUND

1. Field of the Invention

The present invention relates to machines used to separate particulate materials or mixed recyclable materials into difference fractions, and more particularly, to a disc construction for a disc screen that allows its discs to be more easily removed and replaced.

2. Related Art

Disc screens have long been used to separate particulate materials such as wood chips into difference fractions, according to size. More recently disc screens have been used to separate or classify mixed recyclable materials into respective streams of similar materials such as broken glass, containers, mixed paper and newspaper.

A disc screen typically includes a frame in which a plurality of rotatable shafts are mounted in parallel relationship. A plurality of discs are mounted on each shaft and a chain drive rotates the shafts in the same direction. The discs on one shaft interleave with the discs on each adjacent shaft to form screen openings between the peripheral edges of the discs. The size of the openings determines the dimension (and thus the type) of material that will fall through the screen. Rotation of the discs, which have an irregular outer contour, agitates the mixed recyclable materials to enhance classification. The rotating discs also propel the larger articles which are too big to fall between the discs across the screen. The general flow direction extends from an input area where the stream of material pours onto the disc screen to an output where the larger articles pour off of the disc screen. The smaller articles fall between the discs onto another disc screen or a conveyor, or into a collection bin.

The discs of a disc screen normally have a central opening or bore that allows them to be slid over the end of a shaft which may have a round or square cross-section. See for example U.S. Pat. No. 4,836,388 of Bielagus granted Jun. 6, 1989. Over time, the discs wear out and must be replaced. It is not practical to re-surface or repair damaged or worn discs without removing them from the shafts of the disc screen. However, it is tedious to dismount the ends of the shafts of a disc screen from their respective bearings so that the old discs can be removed and replaced by sliding the discs off the ends of the shafts. Moreover, if only singe disc is worn out or broken, it is usually necessary to remove several discs before the damaged or broken disc can be slid off the shaft. In order to alleviate these problems, a split disc was developed by CP Manufacturing, Inc. of National City, Calif. See U.S. Pat. No. 6,318,560 of Robert M. Davis granted Nov. 20, 2001. The split disc is comprised of two identical halves which are assembled around a shaft and tightly held together by a pair of bolt assemblies which clamp the disc to the shaft. Each disc half is made of an outer rubber portion which is stiffened with a rigid internal metal frame embedded inside the rubber portion. While the aforementioned patented two-piece disc construction has been commercially successful, it would be desirable to provide a disc construction that is even more convenient to remove and install.

### SUMMARY

In accordance with an embodiment of the present invention, a disc for releasable attachment to a shaft of a disc screen apparatus includes a generally ring-shaped hub. The hub has a bore and a split defining a pair of opposing ends. The hub also has a hinge intermediate the opposing ends that permits the opposing ends of the hub to be separated a predetermined distance sufficient to allow the shaft of the disc screen apparatus to pass between the opposing ends into the bore. A plurality of outer impacting elements are supported on the hub and are configured for engaging materials to be classified and propelling the materials in a conveying direction when the hub is rotated. A mechanism is provided to secure the hub to the shaft so that the shaft extends through the bore.

Other features and advantages of the present invention will become more readily apparent to those of ordinary skill in the art after reviewing the following detailed description and accompanying drawings.

### BRIEF DESCRIPTION OF THE DRAWINGS

FIG. 1 is an exploded perspective view of a shaft of a disc screen with a pair of hinged discs, one being mounted on the shaft and another one in position for mounting;

FIG. 2 is a side elevation view, with portions broken away, of one of the hinged discs of FIG. 1;

FIG. 3 is an end elevation view of the hinged disc of FIG. 2 taken from the left side of FIG. 2 and illustrating details of embedded structures in phantom lines;

FIG. 4 is a cross-sectional view of the hinged disc of FIG. 2 taken along line 4-4 of FIG. 2;

FIG. 5 is a perspective view of one of the metal inserts of the hinged disc of FIG. 2;

FIG. 6 is a side elevation view of a hinged metal insert of an alternate embodiment of the present invention;

FIG. 7 is an end elevation view of the hinged metal insert of FIG. 6.

FIG. 8 is a side elevational view of another embodiment of one of the hinged discs.

### DETAILED DESCRIPTION

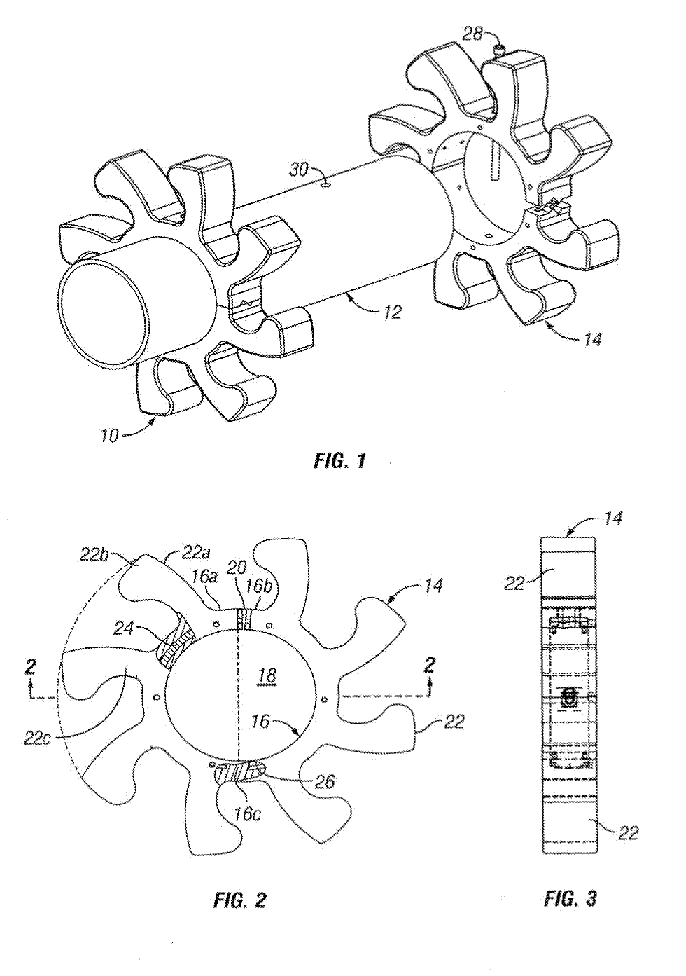

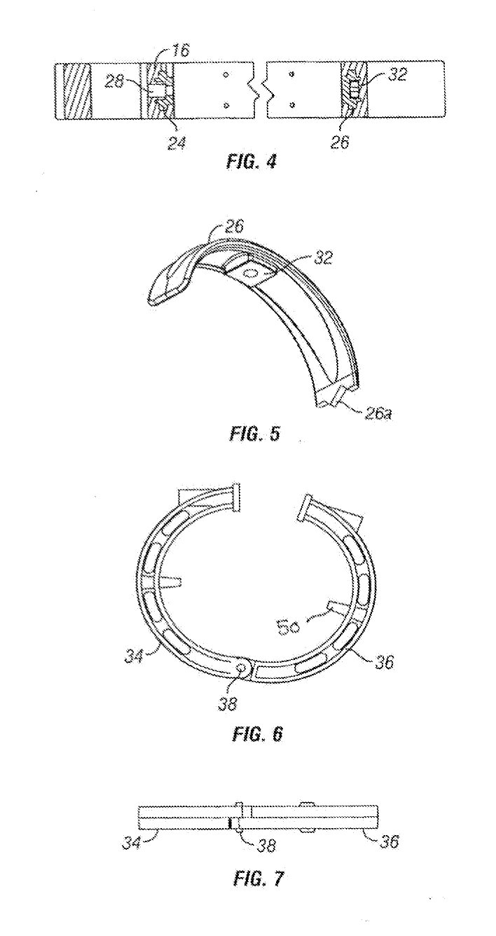

Referring to FIG. 1, a first hinged disc 10 is mounted on a hollow round shaft 12 and a second identical hinged disc 14 is in position for mounting on the shaft 12. Only a portion of the shaft 12 is illustrated in FIG. 1. The shaft would typically be long enough to support a dozen or more discs in spaced apart fashion. The ends of the shaft 12 are supported by bearing assemblies (not illustrated) of a disc screen (not illustrated) such as those disclosed in U.S. Pat. No. 6,250,478 of Robert M. Davis granted Jun. 26, 2001 and U.S. Pat. No. 6,648,145 of Robert M. Davis et al. granted Nov. 18, 2003, and co-pending U.S. patent application Ser. No. 10/044,222 of Robert M. Davis filed Nov. 21, 2005, the entire disclosures of which are incorporated herein by reference.

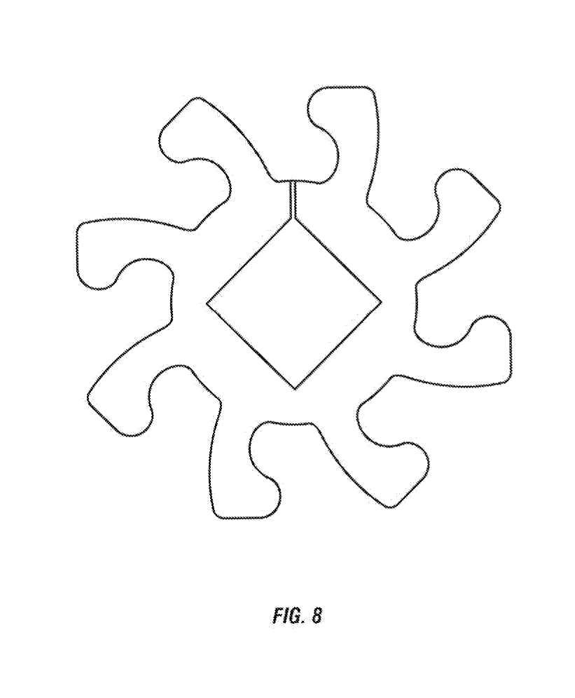

Referring to FIG. 2, each hinged disc, such as the hinged disc 14, is specially configured for use in classifying mixed recyclable materials. The hinged disc 4 includes a generally ring-shaped 5 hub 16 formed of an elastomeric material, i.e. a rubber-like synthetic polymer such as silicone rubber or polyurethane. The hub has a bore 18 which may be of circular, square (e.g., FIG. 8), or other shapes to accommodate shafts having matching outer cross-sections. The hub has a tapered split or slot 20 therethrough defining a pair of opposing ends 16a and 16b. A proximal end of slot 20 interfaces with the through bore or opening 18 and a distal end forms a tapered slit which intersects with the radial perimeter. The hub 16 also has a hinge segment 16c intermediate the opposing ends 16a and 16b that permits them to be manually separated a sufficient to distance to allow the shaft 12 to pass between the opposing ends 16a and 16b into the bore 18. As illustrated by the dotted line in FIG. 2, one side of the taper of slot 20 is parallel with the horizontal centerline of the disc. A plurality of outer impacting elements or fingers 22 in the form of radially extending arms are supported on the hub 16 and are configured for engaging materials to be classified (not illustrated) and propelling the materials in a conveying direction when the hub is rotated. The hinged disc 14 is designed to be rotated clock-wise in FIG. 2 for propelling materials to the right. The impacting elements or fingers 22 are also made of elastomeric material and are integrally formed with the hub 16. In the illustrated embodiment, the disc has eight integrally formed fingers 22, as seen in FIG. 2.

The hub segment 16c has sufficient flexibility to allow the opposing ends 16a and 16b to be manually separated for mounting the hinged disc 14 on the shaft 12. A pair of identical rigid inserts 24 and 26 are embedded in the hub 16 on opposite sides of the hinge segment 16c. The inserts 24 and 26 are preferably made of metal, such as cast Aluminum, and are each partially ring-shaped, as illustrated in FIG. 5. The lightweight metal inserts 24 and 26 provide additional strength and rigidity to accommodate means for securing the hub 16 to the shaft 12 so that the shaft 12 extends through the bore 18. The opposing ends 16a and 16b of the hub 16 and the inserts 24 and 26 have complementary mating shapes to aid in aligning these opposing ends when the hub 16 is secured to the shaft 12. More particularly, the mating shapes have a saw-tooth configuration such as 26a as best seen in FIG. 5.

In the form illustrated, the means for securing the hub 16 to the shaft 12 comprises a fastener in the form of a stainless steel bolt or threaded fastener 28 (FIG. 1) that extends through the hub 16, through a hole in the shaft such as 30. One insert, such as the insert 26 (FIG. 5) has a stainless steel nut or threaded block 32 seated in a rectangular aperture. The bolt 28 extends through the rectangular aperture in the other insert 24, and through the shaft 12, and its male end is screwed into the female threaded nut 32 held in the rectangular aperture in the insert 26 and embedded within the hub 16. Other forms of securing means can be utilized, such as a bolt that does not penetrate the shaft 12 but instead holds the hub 16 tightly clamped around the shaft 12. In such a case the hub 16 should be dimensioned such that the opposing ends 16a and 16b do not contact each other, leaving the split 20 open when the hub 16 engages the shaft 12. This allows the hub to be tightened against the shaft 12 by drawing the opposing ends 16a and 16b toward each other. The securing means could also take the form of ancillary collars, clamps, brackets and/or sleeves for indirectly attaching or holding the hub 16 to the shaft 12 in releaseable fashion.

The impacting elements 22 (FIG. 2) are specially configured for classifying a stream of mixed recyclable materials. The leading edge 22a has a slightly curved shape. The outer end of each impacting element 22 is formed with an enlarged lobe 22b that takes longer to wear away. The spoke portion 22c of each impacting element 22 is dimensioned to allow the element 22 to flex rearwardly under load, allowing some of the leading edge 22a to contact the materials being classified.

The hinged disc 14 is preferably integrally molded as one unitary piece of elastomeric material in a mold (not illustrated) after the inserts cast Aluminum 24 and 26 have been positioned within the mold. The use of synthetic rubber, polyurethane or other similar durable elastomeric materials ensures that the impacting elements 22 will have high friction impacting surfaces to maximize their propelling. The use of elastomeric material also minimizes the likelihood that glass containers will be broken.

The hinged disc 14 is easier to dismount and mount than prior split discs because it is lighter, and only requires a single bolt to be removed and replaced. Also, the repairman does not need to hold up two separate disc pieces around the shaft, and try to insert bolts at the same time. A disc screen may incorporate several hundred discs, and the savings in terms of materials (expensive stainless steel bolts) and installation time can be significant. Moreover, the lighter weight of the hinged disc 14 than conventional split disks lessens the likelihood of damaged bearings, bent shafts and broken shafts.

Instead of using a segment of an elastomeric hub as the hinge, in an alternate embodiment the hinge may comprise a mechanical hinge assembly portion of the hub. Referring to FIGS. 6 and 7 the adjacent ends of a pair of cast Aluminum semi-circular inserts 34 and 36 are pivotally connected by a pin 38. These inserts are placed inside a mold and encased in suitable elastomeric material (not illustrated) and to form impacting elements (not illustrated) at the same time. The inserts 34, 36 have opposing, inwardly directed support columns 50 jointly formed with the inserts within the disc body, as seen in FIG. 6.

While I have described alternate embodiments of my invention, variations and modifications will occur to those skilled in the art. For example, both the shape and number of the plurality of outer impacting elements can widely varied to meet the needs of the materials being classified. For example, the disc could have a star configuration with rounded or sharp tips, or it could have a square configuration with rounded corners, or it could have an undulating outer contour as disclosed in U.S. Pat. No. 4,795,036 of Williams, or it could have a triangular contour with curved edges joining angled apices as disclosed in U.S. Pat. No. 5,799,801 of Clark et al. The bore 18 need not be circular, but could be rectangular (e.g., FIG. 8), triangular, oval, etc. to accommodate shafts having matching outer cross-sections. The hinged disc could also be made entirely of metal for the purpose of crushing glass. Therefore, the protection afforded my invention should only be limited in accordance with the scope of the following claims.

1-20. (canceled)

21. A multi-finger clamshell disc for use with an apparatus for classifying a stream of mixed recyclable materials of varying sizes and shapes which comprises:
a resilient disc body configured in a thin flat circular shape defining a radial perimeter, a plurality of fingers integrally formed as an appendage to said radial perimeter, the fingers extending outwardly from the radial perimeter in a evenly spaced manner;
said body having a centrally positioned square opening therethrough, with radial corners, said square opening sized to fit onto a shaft of said apparatus;
said body having a tapered slot therethrough with a proximal end interfacing with said square opening and a distal end tapering to a slit intersecting with said radial perimeter, and a hinge opposite said slot, the slot arranged in linear alignment with said hinge; and
a plurality of inserts molded within said body adjacent to said hinge and said slot with the inserts configured to receive at least one threaded fastener for compressing said notch and said slot together thereby tightly gripping the shaft of said apparatus after the body has been spread open, in clamshell manner, over the shaft and springs back in shape.

22. The multi-finger clamshell disc as recited in claim 21, wherein said resilient disc body further comprises eight integrally formed fingers with the body fabricated from polyurethane material.

23. The multi-finger clamshell disc as recited in claim 21, wherein said tapered slot has one side of the taper parallel with a horizontal centerline of the disc.

24. The multi-finger clamshell disc as recited in claim 21, wherein said plurality of inserts are at least partially ring shaped and are of metallic construction.

25. The multi-finger clamshell disc of claim 24, wherein said plurality of inserts further comprises a plurality of support columns interfacing with the partially ring-shaped members and jointly formed within the disc body.

26. The multi-finger clamshell disc of claim 24, wherein said plurality of inserts further comprises at least one support column interfacing with one of the partially ring-shaped members and jointly formed within the disc body.

27. The multi-finger clamshell disc as recited in claim 26, wherein at least one of said inserts includes a threaded block for receiving said threaded fastener.

28. The multi-finger clamshell disc as recited in claim 27, wherein said plurality of inserts further comprises at least one screw fastener inserted through the ring-shaped member, the support column and threaded into the threaded block for tightly gripping the shaft of said apparatus after the disc body has been spread open in clamshell manner over the shaft and springs back in shape.
